(19) United States
(12) Patent Application Publication
(10) Pub. No.: US 2018/0226002 A1
(43) Pub. Date: Aug. 9, 2018

(54) DISPLAY SYSTEM

(71) Applicant: Sandow Material Group Holdings, LLC, New York, NY (US)

(72) Inventor: Adam I. Sandow, Boca Raton, FL (US)

(73) Assignee: Sandow Material Group Holdings, LLC, New York, NY (US)

(21) Appl. No.: 15/677,621

(22) Filed: Aug. 15, 2017

Related U.S. Application Data
(60) Provisional application No. 62/454,535, filed on Feb. 3, 2017.

(51) Int. Cl. G09F 9/37

(52) U.S. Cl. CPC G09F 9/375

(57) ABSTRACT

A display system is provided. The display system can include a support surface having a grid of magnetic elements arranged in at least two columns of spaced apart magnet elements and at least two rows of spaced apart magnet elements, and a plurality of display elements such that each display element includes at least one magnetic element corresponding to a magnetic element of the grid of magnet elements.

### CROSS-REFERENCE TO RELATED APPLICATIONS

The present application claims benefit of U.S. Provisional Patent Application No. 62/454,535, filed Feb. 3, 2017, the entirety of which is incorporated herein by reference.

### FIELD OF THE INVENTION

The present invention relates generally to a display system.

### BACKGROUND

Display systems can be temporary structures, such as those found at conferences and trade shows, or permanent structures, such as those often found in office, school, or hotel lobbies. Display systems can also be interactive, such as those found in certain museums. There are a variety of different kinds of display systems, and for each kind there are typically a number of functional concerns with respect to providing the best display system for a particular situation.

### SUMMARY

In various embodiments, a display system is described. The system can include a support surface having a grid of magnetic elements arranged in at least two columns of spaced apart magnetic elements and at least two rows of spaced apart magnetic elements, and a plurality of display elements. Each display element can include at least one magnetic element corresponding to at least one magnetic element of the grid of magnetic elements on the support surface. At least one of the support surface or the display element includes a magnetic element that is a permanent magnet such that the display element can be removeably attached to the support surface.

### BRIEF DESCRIPTION OF THE DRAWINGS

The features, objects, and advantages of the present invention will become more apparent to one skilled in the art from the following description and claims when read in light of the accompanying drawings.

FIG. 1 is a front view of a display system, in accordance with some embodiments described herein.

FIG. 2 is a close up of a portion of the display system in FIG. 1.

FIG. 3 is a perspective view of a display system, in accordance with some embodiments described herein.

FIG. 4 is a back view of a display element, in accordance with some embodiments described herein.

FIG. 5A is a front view of a display system, in accordance with some embodiments described herein; FIG. 5B is a back view of a display element, in accordance with some embodiments described herein; FIG. 5C is a back view of a display element, in accordance with some embodiments described herein.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected,” refer to a relationship wherein structures are secured or attached to one another either directly or indirectly through intervening structures, as well as both movable or rigid attachments or relationships, unless expressly described otherwise.

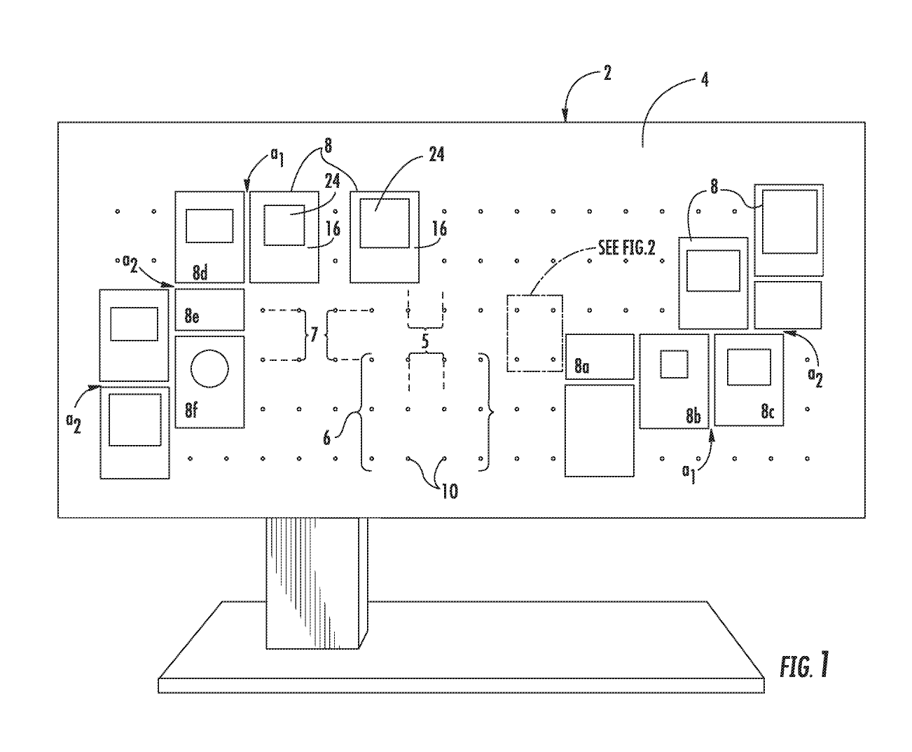

In various embodiments, a display system is described. In some embodiments, the display system includes a support surface and a plurality of display elements. The support surface includes a grid of magnetic elements that can include at least two columns of spaced apart magnetic elements and at least two rows of spaced apart magnetic elements. The support surface includes an outer surface that is generally planar. In some embodiments, the support surface can be a planar, non-magnetic material, such as a non-magnetic metal, wooden sheet (particle board, plywood, etc.), or a polymer sheet with the grid of magnetic elements secured thereto. In some embodiments, the support surface can be a planar, magnetic material (e.g., a metal, such as steel). In some embodiments, for example, as shown in FIG. 1, the support surface can be more than one sheet of planar, non-magnetic material with the grid of magnetic elements secured thereto. Regardless of the composition of the support surface, the support surface can also be a uniformly curved surface.

The grid of magnetic elements having at least two columns of spaced apart magnetic elements and at least two rows of spaced apart magnetic elements can include magnetic elements selected from, for example, ferromagnetic materials, magnets, rare earth magnets, etc. Rare earth magnets include, for example, permanent magnets made from alloys of rare earth elements. In some embodiments, a display element includes at least one magnetic element corresponding to at least one magnetic element of the grid of magnetic elements on the support surface. In some embodiments, a display element includes at least two magnetic elements corresponding to at least two magnetic elements of the grid of magnetic elements on the support surface, or at least three magnetic elements corresponding to at least three magnetic elements of the grid of magnetic elements, or at least four magnetic elements corresponding to at least four magnetic elements of the grid of magnetic elements.

FIGS. 1-5C illustrate a display system 2 including a support surface 4, a grid of magnetic elements 6 arranged in at least two columns 5 of spaced apart magnetic elements and at least two rows 7 of spaced apart magnetic elements, and a plurality of display elements 8. The support surface 4 can be generally planar or can have a uniformly curved surface. In some embodiments, the support surface 4 is not magnetic. In some embodiments, as shown in FIGS. 1-3 and 5A, the magnetic elements 10 in the grid of magnetic elements 6 include permanent magnets 12 that are secured to the support surface 4 with a fastener 14. In some embodiments, the fastener 14 is selected from a screw, nail, pin, or any suitable fastener. In some embodiments, magnets 12 in the grid of magnetic elements 6 are secured to the support surface 4 with an adhesive. In some embodiments, the adhesive is a glue, epoxy, paste, or any suitable adhesive. In some embodiments, the outer surface of the magnets 12 is flush with or below (counter-sunk) the outer surface of the support surface 4.

In some embodiments, the grid of magnetic elements 6 can be arranged in at least two columns of spaced apart magnetic elements and at least two rows of spaced apart magnetic elements. In some embodiments, the grid of magnetic elements can be arranged in at least three columns of spaced apart magnetic elements and at least three rows of spaced apart magnetic elements. In some embodiments, the magnetic elements 10 forming the at least two columns of spaced apart magnetic elements and the at least two rows of spaced apart magnetic elements include permanent magnets 12. In some embodiments, the permanent magnets 12 are rare earth magnets. In some embodiments, magnets 12 include a samarium-cobalt alloy or a neodymium alloy. In some embodiments, two or more of the magnets 12 are oriented to have the same polarity facing out of the support structure 4. In some embodiments, each of the magnets 12 are oriented to have the same polarity facing out of the support structure 4.

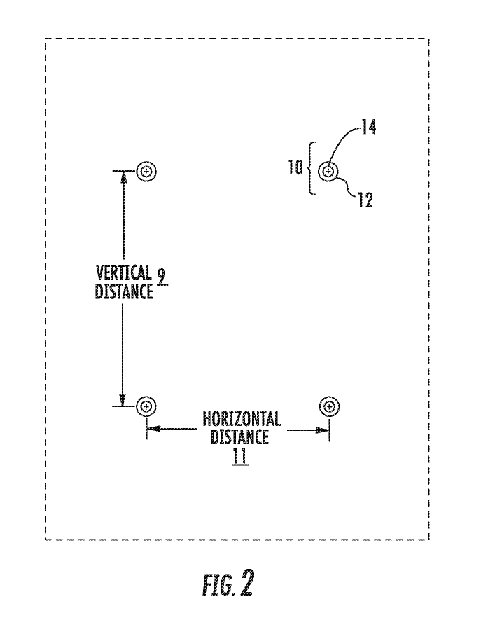

As shown in FIGS. 1 and 2, in some embodiments, the grid of magnetic elements 6 is configured such that each set of adjacent rows of the at least two rows are spaced apart by a first vertical distance 9, and each set of adjacent columns of the at least two columns are spaced apart by a first horizontal distance 11. In some embodiments, the first vertical distance 9 and the first horizontal distance 11 are the same. In some embodiments, the first vertical distance 9 and the first horizontal distance 11 are different.

In some embodiments, the magnetic elements 10 can have a particular shape or can be countersunk in a depression having a particular shape. In some embodiments, the magnets 12 can have a particular shape, which can be the same or different from that of the depression. In some embodiments, the fastener 14 can have a particular shape. In some embodiments, the magnetic elements 10, the magnets 12, the fastener 14, the depression containing each magnetic element, or any combination thereof can have a shape selected from a circle, triangle, square, rectangle, parallelogram, pentagon, hexagon, octagon, etc. In some embodiments, one or more of the magnetic elements 10, the magnets 12, the fastener 14, the depression containing each magnetic element, or any combination thereof can have a first shape, and one or more of the magnetic elements 10, the magnets 12, the fastener 14, or any combination thereof can have a second shape, or a third shape, etc. In some embodiments, each magnetic element 18 on the display element can have the same shape as each depression containing magnetic elements 10 in the support surface. This facilitates proper orientation of the display elements even when the display element only utilizes one magnetic element.

In some embodiments, the grid of magnetic elements 6 includes at least three columns of spaced apart magnetic elements. In some embodiments, the grid of magnetic elements 6 includes at least four columns of spaced apart magnetic elements. In some embodiments, the grid of magnetic elements 6 includes at least five columns of spaced apart magnetic elements. In some embodiments, the grid of magnetic elements 6 includes at least six columns of spaced apart magnetic elements. In some embodiments, the grid of magnetic elements 6 includes at least seven columns of spaced apart magnetic elements. In some embodiments, the grid of magnetic elements 6 includes at least eight columns of spaced apart magnetic elements. In some embodiments, the grid of magnetic elements 6 includes at least nine columns of spaced apart magnetic elements. In some embodiments, the grid of magnetic elements 6 includes at least ten columns of spaced apart magnetic elements. In some embodiments, the grid of magnetic elements 6 includes at least fifteen columns of spaced apart magnetic elements.

In some embodiments, the grid of magnetic elements 6 includes at least three rows of spaced apart magnetic elements. In some embodiments, the grid of magnetic elements 6 includes at least four rows of spaced apart magnetic elements. In some embodiments, the grid of magnetic elements 6 includes at least five rows of spaced apart magnetic elements. In some embodiments, the grid of magnetic elements 6 includes at least six rows of spaced apart magnetic elements. In some embodiments, the grid of magnetic elements 6 includes at least nine rows of spaced apart magnetic elements.

In some embodiments, the grid of magnetic elements 6 is configured such that each set of adjacent columns are spaced apart by a first horizontal distance 11, and each set of adjacent rows are spaced apart by a first vertical distance 9. In some embodiments, the first vertical distance 9 and the first horizontal distance 11 are the same. In some embodiments, the first vertical distance 9 and the first horizontal distance 11 are different.

In some embodiments, the support surface 4 has a predetermined width and a predetermined height in order to provide space for the grid of magnetic elements 6 arranged in at least two columns of spaced apart magnetic elements and at least two rows of spaced apart magnetic elements.

In some embodiments, the predetermined width of support surface 4 is between about 3 feet to about 20 feet. In some embodiments, the predetermined width is between about 7 feet to about 17 feet. In some embodiments, the predetermined width is between about 3 feet to about 8 feet.

In some embodiments, the predetermined height of support surface 4 is between about 1 foot to about 10 feet. In some embodiments, the predetermined height is between about 1 foot to about 8 feet. In some embodiments, the predetermined height is between about 2 feet to about 4 feet.

In some embodiments, the support surface 4 can be made out of a non-magnetic metal, plastic, wood (e.g., particle board, plywood, etc.), graphite, or any other suitable material. In some embodiments, the support surface 4 can be made out of a magnetic material (e.g., a metal, such as steel).

In some embodiments, the predetermined spacing for the at least two columns of spaced apart magnetic elements in the grid of magnetic elements 6 is a first horizontal distance 11. In some embodiments, the horizontal distance 11 is between about 2 to about 55 inches, between about 3 to about 27.5 inches, or between about 4 and about 12 inches.

In some embodiments, the predetermined spacing for the at least two rows of spaced apart magnetic elements in the grid of magnetic elements 6 is a first vertical distance 9. In some embodiments, the vertical distance 9 is between about 3 to about 37.5 inches, between about 4 to about 22.5 inches, or between about 5 and about 15 inches.

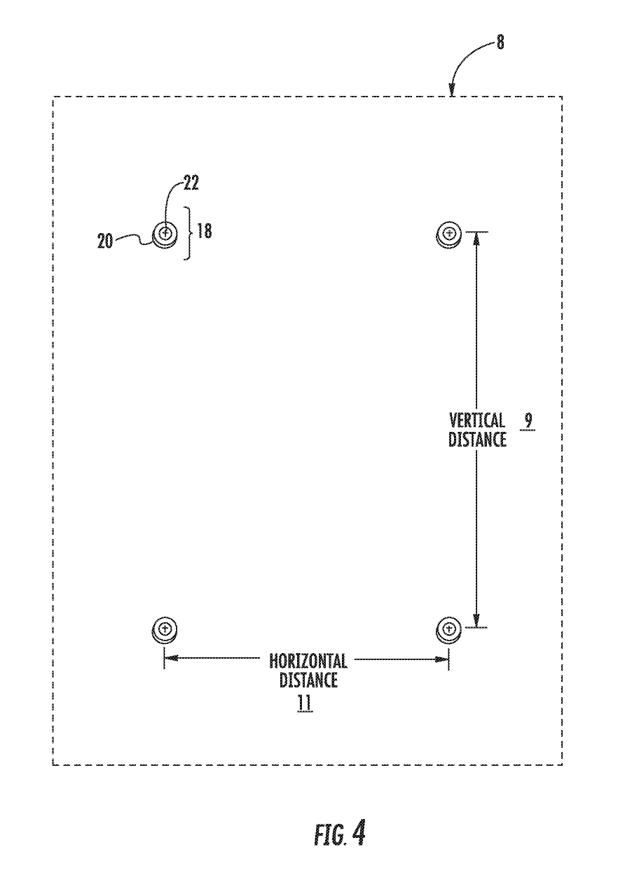

As shown in FIG. 4, in some embodiments, the plurality of display elements 8 includes a number of magnetic elements 18. As shown in FIG. 1, in some embodiments, the plurality of display elements 8 can be sized identically or sized differently. In some embodiments, the plurality of display elements 8 includes a first display element having a first number of magnetic elements 18 and a second display element having a second number of magnetic elements 18. In some embodiments, for example when the plurality of display elements 8 are sized identically, the first number of magnetic elements 18 and the second number of magnetic elements 18 are the same. In some embodiments, for example when the plurality of display elements 8 are sized differently, the first number of magnetic elements 18 and the second number of magnetic elements 18 are different.

In some embodiments, the display system 2 includes a plurality of first display elements and a plurality of second display elements 8. As shown in FIG. 1, in some embodiments, the first and second display elements 8 can be sized and configured so that when any two display elements 8 are attached to adjacent rows of the grid of magnetic elements 6, there is a uniform horizontal space (a₂) between adjacent edges of the two display elements. In some embodiments, the first and second display elements can be sized and configured so that when any two display elements are attached to adjacent columns of the grid of magnetic elements 6, there is a uniform vertical space (a₁) between adjacent edges of the two display elements. In some embodiments, the plurality of first display elements 8 and plurality of second display elements 8 can be sized and configured so that when any two display elements are attached to either adjacent rows or adjacent columns of the grid of magnetic elements 6, there is a uniform space (a₁) and a uniform space (a₂) between adjacent edges of the plurality of first display elements 8 and plurality of second display elements 8. In some embodiments, the uniform vertical space (a₁) and the uniform horizontal space (a₂) are equal.

In some embodiments, the plurality of display elements 8 can have a particular shape. In some embodiments, one or more of the display elements 8 can have a first shape and one or more of the display elements 8 can have a second shape, or a third shape, etc. In some embodiments, the plurality of display elements 8 can have a shape selected from triangle, square, rectangle, parallelogram, pentagon, hexagon, octagon, etc.

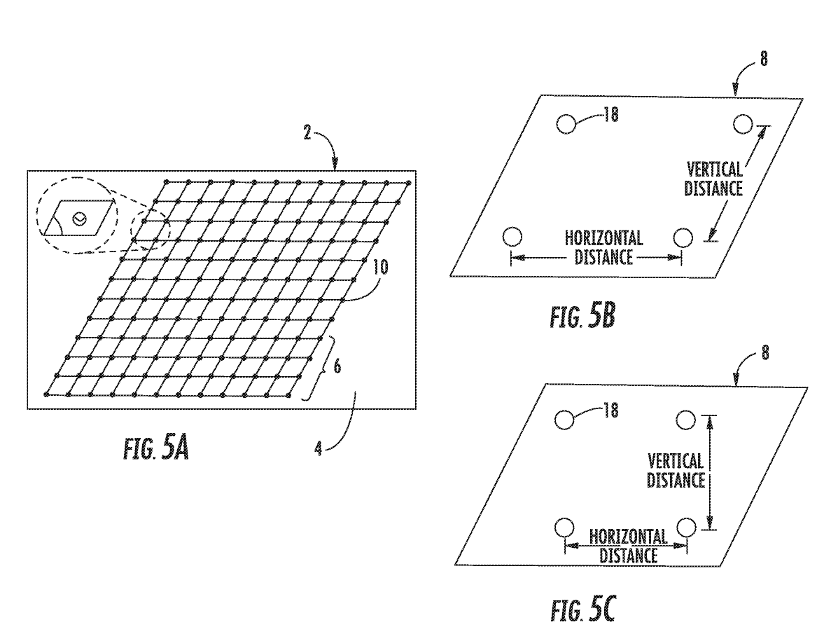

In some embodiments, the grid of magnetic elements 6 can be oriented to have a shape associated with one or more of the display elements 8. In some embodiments, the grid of magnetic elements 6 and the display elements 8 will have the same shape. As shown in FIG. 5A, in some embodiments, the grid of magnetic elements 6 can be configured with so that the magnetic elements 10 are oriented in a grid of angled columns. In some embodiments, the magnetic elements 10 in adjacent rows of the at least two rows are spaced apart by a vertical distance, and the magnetic elements 10 in adjacent columns of the at least two columns are spaced apart by a horizontal distance. In some embodiments, the vertical distance and the first horizontal distance are the same. In some embodiments, the vertical distance and the horizontal distance are different.

As shown in FIG. 5A, in some embodiments, the columns can be offset at a uniform angle (θ) from horizontal other than 90 degrees, while the columns can be perpendicular (90 degrees from horizontal) to the rows in other embodiments. For example, in some embodiments, the columns are offset at an angle ranging from 30 degrees to 87.5 degrees, or from 45 degrees to 85 degrees, or from 50 degrees to 80 degrees, or any combination thereof.

As shown in FIG. 1, in some embodiments, the display elements 8 can include a display element body 16. In some embodiments, the display element body 16 is a ferromagnetic material. In some embodiments, the display element body 16 is not a ferromagnetic material and includes at least one magnetic element 18. As shown in FIG. 4, in some embodiments, display element 8 can include magnetic elements 18, which can include permanent magnets 20 that are secured to one side of display element body 16 with adhesive or a fastener 22. The permanent magnets 20 can be any suitable permanent magnets, including, for example, magnets made from alloys of rare earth elements. The fastener 22 can be, for example, in some embodiments, selected from a screw, nail, pin, or any suitable fastener. In some embodiments, magnets 20 are secured to the display element body 16 with an adhesive. For example, in some embodiments, the adhesive can be selected from a glue, epoxy, paste, or any suitable adhesive. In some embodiments, the magnetic elements 18 are ferromagnetic materials that allow the display element 8 to be secured to the magnetic elements 10 (e.g., permanent magnets) of the support surface 4.

In some embodiments, each one of a first set of display elements includes a display element body with one row of two magnetic elements attached to the back and each one of a second set of display elements includes a display element body with four magnetic elements arranged in two rows and two columns. In some embodiments, additional sets of display elements can have six or more magnetic elements arranged in two or more rows and three or more columns, or three or more rows and two or more columns.

As shown in FIGS. 5B and 5C, in some embodiments, the magnetic elements 18 on the back of a display element 8 can be oriented to correspond to a portion of the grid of magnetic elements 10 on the support surface 4. As shown in FIG. 5B, in some embodiments, the magnetic elements 18 can be oriented with angled columns in the shape of a parallelogram when the grid of magnetic elements 6 on the support surface 4 are oriented with angled columns in the shape of a parallelogram. As shown in FIG. 5C, in some embodiments, the display element 8 can have one shape (e.g., a parallelogram) and the magnetic elements can be oriented in a different shape, such as, for example, a rectangle. In some embodiments, the magnetic elements 18 can be fastened to the display element 8 in positions such that the horizontal distance between magnetic elements 18 corresponds to the horizontal distance of the magnetic elements 10 on the support surface 4, and the vertical distance between magnetic elements 18 corresponds to the vertical distance of the magnetic elements 10 on the support surface 4.

As shown in FIG. 1, in some embodiments display elements 8 can include a display feature 24. When present, the display feature 24 is secured to the display element body 16 on a side opposite to the side with magnetic elements 18. In some embodiments, for example, a display feature 24 can include a sample of material and, display element body 16 can optionally include a description of the material of display feature 24. In some embodiments, each of the plurality of display elements 8 includes a display feature 24 on a side opposite the side with magnetic elements 18. In some embodiments, the display element body 16 and the display feature 24 are together a display element 8.

Each of the plurality of display elements 8 has a predetermined width and a predetermined height. As shown in FIGS. 1 and 5, in some embodiments, a display element 8 can have a predetermined width that is equal to a specified amount that is less than the value of a multiple (e.g., 2, 3, 4, etc.) (n₁) of the first horizontal distance 11. For example, the plurality of display elements 8 can include a first display element 8a having a predetermined width that covers a span of two horizontally spaced magnetic elements 10 on the grid of magnetic elements 6, a second display element 8b that is adjacent to the first display element 8a and covers a span of two horizontally spaced magnetic elements 10 on the grid of magnetic elements 6, and a third display element 8c that is adjacent to the second display element 8b and covers a span of two horizontally spaced magnetic elements 10 on the grid of magnetic elements 6. In this example, the predetermined widths of display element 8a, display element 8b, and display element 8c is such that there is a specified amount of horizontal space (a₁) between the display elements 8a, 8b, and 8c. In this example, the predetermined width of the display elements 8a, 8b, and 8c is determined by the formula below, by which variable (a₁) is the horizontal space between display elements 8 and variable n₁ is an integer.

Width=(n₁×first horizontal distance #)−a₁ Formula (1)

As shown in FIG. 1, in some embodiments, a display element 8 can have a predetermined height that is equal to a specified amount that is less than the value of a multiple (e.g., 1, 2, 3, 4, etc.) (n₂) of the first vertical distance 9. For example, the plurality of display elements 8 can include a first display element 8d having a predetermined height that covers a span of two vertically spaced magnetic elements 10 on the grid of magnetic elements 6, a second display element 8e that is adjacent to the first display element 8d and covers a span of two vertically spaced magnetic elements 10 on the grid of magnetic elements 6, and a third display element 8f that is adjacent to the second display element 8e and covers a span of two vertically magnetic elements 10 on the grid of magnetic elements 6. In this example, the predetermined height of display element 8d, display element 8e, and display element 8f is such that there is a specified amount of vertical space (a₂) between the display elements 8d, 8e, and 8f. In this example, the predetermined height of the display elements 8d, 8e, and 8f is determined by the formula below, by which variable (a₂) is the vertical space between display elements 8 and variable n₂ is an integer.

Height=(n₂×first vertical distance #)−a₂ Formula (2)

In some embodiments, the predetermined width and the predetermined height of display element 8 can be equal to a specified amount such that the horizontal space (a₁) between adjacent display elements 8 and the vertical space (a₂) between adjacent display elements 8 is the same. In some embodiments, the predetermined width and the predetermined height of each display element 8 can be equal to a specified amount such that the horizontal space (a₁) between adjacent display elements 8 and the vertical space (a₂) between adjacent display elements 8 are different, but are consistent when display elements 8 are attached to adjacent rows and columns of the grid of magnetic elements 6.

In some embodiments, sets of display elements 8 having different sizes can be used with the grid of magnetic elements 6 on the support structure 4. When the grid of magnetic elements 6 has magnetic elements horizontally spaced apart at a distance 11, and magnetic elements vertically spaced apart at a distance 9, then display elements 8 can have a predetermined width using formula (1) where n₁ is 2, 3, or 4 and a predetermined height using formula (2) where n₂ is 1, 2, 3, or 4. The uniform horizontal and vertical spacing (a₁, a₂) can be selected as desired (e.g., 0.5″, 1″, 1.5″, 2″, etc.). For example, a first set of display elements 8 can have a predetermined width and predetermined height in which n₁=n₂=2; a second set of display elements 8 can have a predetermined width and predetermined height in which n₁=2 and n₂=1; a third set of display elements 8 can have a predetermined width and predetermined height in which n₁=n₂=3; a fourth set of display elements 8 can have a predetermined width and predetermined height in which n₁=3 and n₂=4; etc. Alternately, the display elements 8 could include two rows of two magnetic elements 10, where (i) a horizontal distance between magnetic elements 10 in adjacent columns is a multiple of the first horizontal distance greater than one, (ii) a vertical distance between magnetic elements 10 in adjacent rows is a multiple of the first vertical distance greater than one, or (iii) both option (i) and (ii). As would be evident from the relationship between the grid of magnetic elements 6 having magnetic elements spaced apart at a vertical distance 9 and magnetic elements spaced apart at a horizontal distance 11, various sizes and combinations of sizes of display elements 8 can be used in the display system 2.

In some embodiments, the display system 2 includes a plurality of display materials. The plurality of display materials can optionally include a number of magnetic elements. Magnetic elements include ferromagnetic materials, magnets, etc. In some embodiments, display material is a ferromagnetic material or magnetic. Such a display material would not need a magnetic element. For example, a ferromagnetic display material may not need an additional magnetic element. In some embodiments, display material is not a ferromagnetic material or magnetic. Such a display material would include at least two magnetic elements spaced apart at a distance corresponding to at least two magnets of the grid of magnets 6.

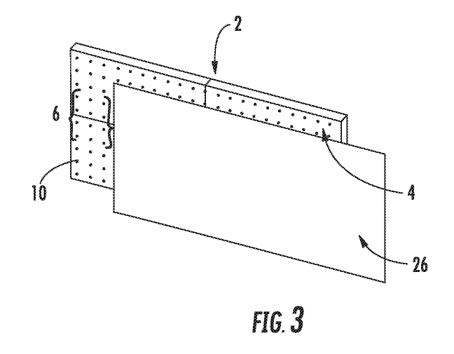

As shown in FIG. 3, in some embodiments, the display system 2 includes a cover sheet 26 that covers the support surface 4 and the grid of magnetic elements 6. In some embodiments, the cover sheet 26 can be selected from a polymer (e.g., a vinyl sheet), paper, coated paper, fabric, or any suitable printable material. The cover sheet 26 can include one or more graphical images, text, or a combination of graphical images and text. In some embodiments, cover sheet 26 includes one or more graphic images, text, or a combination of graphical images and text, which relate to one or more display features on the plurality of display elements. In some embodiments, cover sheet 26 includes one or more graphical images, text, or a combination of graphical images and text, which relate to every display feature secured to the plurality of display elements. The cover sheet 26 can be attached to the support surface 4 using any suitable means. In some embodiments, for example, the cover sheet 26 is attached to the support surface 4 using an adhesive, hook and loop fasteners (e.g., Velcro), tape (e.g., double-sided tape), static friction, magnets, etc.

As would be evident from the description and figures, the display system 2 will generally be used for displaying a plurality of display elements, each having a display feature and optionally having a graphic, text, or both that are related to the display feature. Using the display system described herein, a plurality of display elements can be attached to the support surface of the display system such that the display elements are configured with a specified amount of space between any adjacent display elements. In accordance with the display system described herein, a display element can be removed from the support surface of the display system and subsequently reattached in the identical position from which it was removed or in another position. In accordance with the display system described herein, the support surface having a grid of magnetic elements can be covered with a cover sheet that provides a seamless surface. The display system as described herein provides a museum quality display, and the interchangeability of the display elements and cover sheet provides a sustainable display system.

The foregoing is provided for purposes of illustrating, explaining, and describing embodiments of this invention. Modifications and adaptations to these embodiments will be apparent to those skilled in the art and may be made without departing from the scope or spirit of this invention.

Although the subject matter has been described in terms of exemplary embodiments, it is not limited thereto. Rather, the appended claims should be construed broadly, to include other variants and embodiments, which may be made by those skilled in the art.

1. A display system, comprising:
a support surface comprising a grid of magnetic elements arranged in at least two columns of spaced apart magnet elements and at least two rows of spaced apart magnet elements; and
a plurality of display elements, wherein each display element comprises at least one magnetic element corresponding to a magnetic element of the grid of magnet elements.

2. A display system, comprising:
a support surface comprising a grid of magnetic elements arranged in at least three columns of spaced apart magnet elements and at least three rows of spaced apart magnet elements; and
a plurality of display elements, wherein each display element comprises at least two magnetic elements spaced apart at a distance corresponding to at least two magnet elements of the grid of magnet elements.

3. The display system according to claim 1, wherein the support surface is planar.

4. The display system according to claim 1, wherein the support surface is not magnetic.

5. The display system according to claim 1, wherein the magnet elements forming the at least two columns of spaced apart magnet elements and the at least two rows of spaced apart magnetic elements comprise rare earth magnets.

6. The display system according to claim 1, wherein each of the magnetic elements forming the at least two columns of spaced apart magnet elements and the at least two of spaced apart magnetic elements comprise rare earth magnets that are secured to the support surface by a fastener.

7. The display system according to claim 1, wherein each set of adjacent rows of the at least two rows are spaced apart by a first distance.

8. The display system of claim 7, wherein each set of adjacent columns of the at least two columns are spaced apart by a second distance.

9. The display system according to claim 1, wherein each set of adjacent columns of the at least two or the at least three columns are spaced apart by a second distance.

10. The display system of according to claim 1, wherein at least one of the support surface or the plurality of display elements includes a magnetic element comprising magnets.

11. The display system of according to claim 1, wherein the plurality of display elements comprises a first display element comprising a first number of magnetic elements and a second display element comprising a second number of magnetic elements, wherein the first number and the second number are different.

12. The display system of claim 11, comprising a plurality of first display elements and a plurality of second display elements.

13. The display system of claim 12, wherein the first and second display elements are sized so that
(i) when any two display elements are attached to adjacent rows of the grid of magnetic elements, there is a uniform space between adjacent edges of the two display elements;
(ii) when any two display elements are attached to adjacent columns of the grid of magnetic elements, there is a uniform space between adjacent edges of the two display elements; or
(iii) both option (i) and option (ii).

14. The display system of according to claim 1, wherein each of the display elements comprises a display element body, wherein the display element body is not magnetic and the at least one or the at least two magnetic elements are secured to the display element body.

15. The display system of according to claim 1, wherein each of the display elements comprises a display feature on a side of the display element opposite a side the magnetic elements are secured to.

16. The display system of according to claim 1, further comprising a cover sheet covering the support surface and the grid of magnetic elements.

17. The display system of claim 16, wherein each of the display elements comprises a display feature on a side of the display element opposite a side the magnet elements are secured to.

18. The display system of claim 17, wherein the cover sheet comprises a graphic that relates to one or more of the display features on the display elements.

19. The display system according to claim 1, wherein the display elements are sized so that
(i) when two display elements are attached to adjacent rows of the grid of magnetic elements, there is a uniform space between adjacent edges of the two display elements;
(ii) when two display elements are attached to adjacent columns of the grid of magnetic elements, there is a uniform space between adjacent edges of the two display elements, or
(iii) both option (i) and option (ii).
